(19) United States
(12) Patent Application Publication
(10) Pub. No.: US 2024/0342734 A1
(43) Pub. Date: Oct. 17, 2024

(54) OPERATING METHOD FOR AN ATOMIZER, AND CORRESPONDING COATING SYSTEM

(71) Applicant: Dürr Systems AG, Bietigheim-Bissingen (DE)

(72) Inventors: Frank Herre, Oberriexingen (DE); Michael Baumann, Flein (DE); Thomas Buck, Sachsenheim (DE); Manfred Michelfelder, Steinheim (DE); Sören Wehler, Ludwigsburg (DE); Sandra Berndt, Ditzingen (DE); Sascha Hermann, Korb (DE); Rainer Melcher, Oberstenfeld (DE); Daniel Tino Ackermann, Ditzingen (DE); Patrick Häussermann, Korb (DE); Johannes Höchsmann, Asperg (DE)

(21) Appl. No.: 18/683,784

(22) PCT Filed: Aug. 1, 2022
(86) PCT No.: PCT/EP2022/071516

§ 371 Date: Feb. 15, 2024

(30) Foreign Application Priority Data
Aug. 19, 2021 (DE) 10 2021 121 553.6

(51) Int. Cl. B05B 5/053; B05B 13/04; B05B 16/00

(52) U.S. Cl. CPC B05B 5/0533; B05B 13/0431; B05B 13/0457; B05B 16/95

(57) ABSTRACT

The disclosure relates to an operating method for an atomizer for painting components (e.g. motor vehicle body components) with a paint, with the following
a) Painting with the atomizer with an attachment component mounted on it (e.g. charging ring for exterior painting, protective cover, handling tool),
b) replacing the attachment component on the atomizer with another attachment component (e.g. charging ring for the interior painting, protective cover, handling tool).

The disclosure further comprises a painting system for carrying out the operating method according to the disclosure.

### CROSS-REFERENCE TO RELATED APPLICATIONS

This application is a national stage of, and claims priority to, Patent Cooperation Treaty Application No. PCT/EP2022/071516, filed on Aug. 1, 2022, which application claims priority to German Application No. DE 10 2021 121 553.6, filed on Aug. 19, 2021, which applications are hereby incorporated herein by reference in their entireties.

### FIELD

The disclosure relates to an operating method for an atomizer for painting components (e.g. motor vehicle body components) with a paint. Furthermore, the disclosure relates to a correspondingly designed painting system for carrying out the operating method.

### BACKGROUND

In modern painting systems for painting motor vehicle body components, rotary atomizers are usually used as application devices which have an electrostatic paint charging system in order to increase the application efficiency and minimize the disturbing over-spray (i.e. the proportion of the sprayed paint which does not reach the motor vehicle body component). The electrostatic charging of the paint to be applied can be achieved by an electrostatic external charging. In this case, electrodes (charging rings) are attached to the outside of the atomizer, which electrostatically charge the applied spray of paint.

A distinction must be made here between charging rings for interior painting on the one hand and charging rings for exterior painting on the other.

In the case of exterior painting of motor vehicle body components (i.e. painting of the outer surfaces), the external dimensions of the charging ring are of secondary importance, since sufficient space is available to move the atomizer with the charging ring. The charging rings for exterior painting therefore usually have so-called fingers with embedded electrodes, which protrude from the atomizer and therefore require a relatively large amount of space.

For interior painting in the interior of motor vehicle body components, on the other hand, the atomizer with the charging ring must have relatively compact external dimensions, since there is relatively little space available in the interior of motor vehicle body components for moving the atomizer with the charging ring. Typical charging rings for interior painting therefore have very short electrodes for electrostatic paint charging.

In practice, therefore, painting robots for interior painting and painting robots for exterior painting are combined in a paint booth. The painting robots for interior painting then carry an atomizer with an appropriately adapted charging ring for interior painting, which requires only a small amount of space. The painting robots for exterior painting, on the other hand, use an atomizer with a correspondingly adapted charging ring for exterior painting, which has protruding fingers with embedded electrodes and requires correspondingly more space.

A disadvantage of this technical solution is the fact that specially adapted painting robots and atomizers are always required, which are optimized for interior painting and exterior painting of the vehicle body components respectively.

Furthermore, a painting system is known from EP 1 634 651 A1 in which the charging rings for exterior painting can be deposited if the atomizer operates without an electrostatic paint charging, since a charging ring is then not required. However, this technical teaching does not solve the above-described problem that correspondingly adapted charging rings are required for interior painting on the one hand and for exterior painting on the other. In this prior art, too, correspondingly adapted rotary atomizers or painting robots are required for the exterior painting on the one hand and for the interior painting on the other.

With regard to the technical background of the disclosure, reference should also be made to EP 3 320 981 A1, DE 10 2014 017 895 A1, EP 0 796 665 A2 and DE 10 2019 215 079 A1.

### BRIEF DESCRIPTION OF THE DRAWINGS

FIGS. 1A, 1B show a flow diagram to illustrate the operating method according to the disclosure.

FIGS. 2A-2C show various views of a deposition ring for depositing a charging ring for interior painting.

FIGS. 3A, 3B show various views of a modified embodiment similar to the deposition ring according to FIGS. 2A-2C.

FIG. 4 shows a perspective view of a deposition ring for depositing a charging ring for exterior painting.

FIG. 5 shows a perspective view of a rotary atomizer with a charging ring for exterior painting.

FIG. 6 shows a perspective view of the rotary atomizer from FIG. 5, but with a charging ring for the interior painting.

FIGS. 7A and 7B show various views of a depositing device for replacing the charging rings.

FIGS. 8A-8C show various views of another example of a depositing device with a turntable.

FIGS. 9A-9C show various views of another possible embodiment of a depositing device with swiveling deposition rings.

FIGS. 10A-10C again show various views of a modified example of a depositing device.

FIGS. 11A-11C show various views of a charging ring for exterior painting with a protective handle for gripping the charging ring.

FIG. 12 shows a schematic diagram of a painting system with a mobile painting robot and changing and cleaning stations.

FIG. 13 shows a top view of a painting booth with several painting robots.

FIG. 14 shows a front view of the paint booth from FIG. 13 in an embodiment with eight robots inside the paint booth.

FIG. 15 shows a variation of FIG. 14 with only four painting robots inside the painting booth.

FIG. 16 shows a variation of FIGS. 8A-8C with a linear displacement instead of the rotary table.

### DETAILED DESCRIPTION

In accordance with the prior art, the operating method according to the disclosure uses an atomizer for painting components with a paint.

In a preferred embodiment of the disclosure, the atomizer is a rotary atomizer as known per se from the prior art, so that a detailed description of the rotary atomizer can be dispensed with. However, it is also possible within the scope of the disclosure that another type of atomizer is used instead of a rotary atomizer.

In the preferred embodiment of the disclosure, motor vehicle body components are painted. However, the components to be painted need not necessarily be motor vehicle body components within the scope of the disclosure. Rather, other types of components may also be painted within the scope of the disclosure.

First of all, the operating method according to the disclosure, in accordance with known prior art painting methods, provides that the components to be painted are painted by the atomizer, with an attachment component being mounted on the atomizer. This attachment component can be, for example, an electrode arrangement (charging ring) which is used for electrostatic external charging of the applied paint and is optimized for painting external surfaces of the motor vehicle body components (i.e. for exterior painting), as has already been explained above with regard to the prior art. However, there is also the alternative possibility that the mounted attachment component is an electrode arrangement for interior painting.

The operating method according to the disclosure is now characterized in that the attachment component mounted on the atomizer (e.g. electrode arrangement for exterior painting) is replaced by another attachment component.

For example, this other attachment component may be an electrode arrangement for external electrostatic charging, which is suitable and optimized for painting a motor vehicle body interior of the motor vehicle body components and thus serves for interior painting.

However, the disclosure is not limited to the replacement of attachment components optimized for exterior painting on the one hand and for interior painting on the other hand. Within the scope of the disclosure, it is also possible that the other attachment component is a protective cover which can cover an exchange interface on the atomizer. After dismantling the attachment component mounted on the atomizer (e.g. electrode assembly for exterior painting), the protective cover is then mounted on the exchange interface, thereby protecting the exchange interface or the atomizer.

Furthermore, within the scope of the disclosure, it is also possible that the other attachment component is a handling tool that can be used to operate vehicle assemblies. For example, the handling tool can serve to open or close doors, hoods or flaps of the motor vehicle body components. In this case, therefore, it is possible for an electrode arrangement for electrostatic external charging or the handling tool to be optionally mounted on the atomizer. After the handling tool has been mounted, a painting robot can then also serve as a handling robot (e.g. door opener, hood opener).

However, the other attachment component may also be another type of attachment component. Thus, with regard to the other attachment component, the disclosure is not limited to the examples described above (electrode arrangement for interior/exterior painting, protective cover, handling tool), but can in principle also be implemented with other types of attachment components that can be interchanged. For example, it is also possible for a protective cover to be replaced by a handling tool, to name just one example.

In the preferred embodiment of the disclosure, however, the attachment components to be replaced are an electrode arrangement for exterior painting on the one hand and an electrode arrangement for interior painting on the other. It should be mentioned here that the disclosure optionally permits a change from an electrode arrangement for exterior painting to an electrode arrangement for interior painting or vice versa.

Within the scope of the operating method according to the disclosure, in practice the attachment component mounted on the atomizer (e.g. electrode arrangement for exterior painting) is first dismantled from the atomizer. Subsequently, the dismantled attachment component is then deposited in a depositing device. The other attachment component (e.g. electrode arrangement for interior painting) is then mounted on the atomizer. For example, it is possible to change from an electrode arrangement for external charging to an electrode arrangement for direct charging or without charging.

The dismantled attachment component (e.g. electrode assembly for exterior painting or electrode assembly for interior painting) deposited in the depositing device can then also be cleaned in the depositing device to remove paint residues from the attachment component. For example, the attachment component can be sprayed with cleaning fluid for this cleaning, brushed off and blown on with compressed air to clean the attachment component.

In one variant of the disclosure, the dismantled attachment component is cleaned manually by a maintenance person. For this purpose, the attachment component is deposited in the depositing device and then cleaned by the maintenance person. It is advantageous if the depositing device is located outside the paint booth, for example in a maintenance cell, so that the maintenance person does not have to enter the paint booth to clean the dismantled attachment component.

In another variant of the disclosure, however, the cleaning of the dismantled attachment components is automated in a cleaning device. In this case, the cleaning device can also be located inside the paint booth, since no access of a maintenance person to the paint booth is required for the cleaning process.

It should also be mentioned that the attachment components to be replaced can each have a gripping contour (e.g. handle) in order to be able to grip the attachment component positively and/or frictionally. This simplifies the manual handling of the dismantled attachment components in the depositing device or in the cleaning device.

For example, the attachment components can be removed from the tray for manual cleaning or replacement using a transportable cleaning cover. This cleaning cover protects the attachment components (e.g. charging rings) from further contamination and mechanical destruction. The cleaning cover can also be used to store the charging rings or transport them to other areas of the paint shop (e.g. for maintenance or cleaning work). The depositing table is optionally equipped with a holder in which the cleaning cover can be stored. Conveniently, the charging ring can be rotated in this holder so that manual cleaning can be performed easily and thoroughly.

Furthermore, it should be mentioned that the replacement of the attachment components usually requires a much shorter time than the cleaning of the attachment components. This is significant because in the prior art, the cleaning process requires a relatively long interruption of the painting process. In the operating method according to the disclosure, on the other hand, only a relatively short interruption of the painting process is required if the attachment components are to be cleaned. For this purpose, only a dirty attachment component (e.g. electrode assembly for exterior painting) must be replaced by a clean attachment component (e.g. electrode assembly for interior painting), which can be done relatively quickly. The painting process can then be continued with the replaced clean attachment component and the dismantled attachment component can be cleaned during the painting process.

The exchange of the attachment components can be carried out manually, robotically or by an external device, either manually or automatically.

It should also be mentioned that, within the scope of the disclosure, the same atomizer can be used for both interior painting and exterior painting. For interior painting, the electrode assembly is then mounted on the atomizer, which is optimized for interior painting. For exterior painting, on the other hand, the electrode assembly is mounted on the atomizer that is optimized for exterior painting.

It is already clear from the above description that the attachment components are detachably mounted on the atomizer. For this purpose, a coupling mechanism can be used to enable the mounting or dismantling of the attachment components on the atomizer. This coupling mechanism can, for example, comprise a ball clamping mechanism, a magnetic coupling, a vacuum suction cup, an adhesive connection or swiveling clamping brackets.

Here, the coupling mechanism can optionally have an operating element for optionally releasing or fixing the mechanical connection between the atomizer and the attachment component, wherein the operating element can be arranged on the attachment component so that the coupling mechanism can be released by manually acting on the operating element on the attachment component.

It has already been mentioned above that the dismantled attachment component (e.g. electrode arrangement for exterior painting) can be deposited in a depositing device. The depositing device preferably has several depositing places for the various types of attachment components. For example, the depositing device can have a first depositing place for an electrode assembly for exterior painting and a second depositing place for an electrode assembly for interior painting.

In this case, it is advantageous if the various depositing places cannot be interchanged in order to prevent incorrect placement of the depositing places, so that only one attachment component can be placed at the first depositing place, while only the other attachment component can be placed at the second depositing place.

The above-mentioned non-interchangeability of the depositing places can be achieved mechanically, for example by means of locking surfaces, guide pieces, gripping means and/or clamping brackets.

For example, electrode arrays for exterior painting typically have numerous fingers with embedded electrodes protruding from the atomizer. These fingers can then be inserted into corresponding recesses in the depositing places. In the other depositing place for the electrode arrangement for interior painting, on the other hand, such recesses are absent or the recesses are closed off by barrier surfaces, thus achieving the non-interchangeability in the deposition.

Alternatively, however, it is also possible for the non-interchangeability to be achieved by sensors which can distinguish the depositing places and/or the various attachment components from one another. For example, the individual attachment components can each be provided with an RFID tag (RFID: radio frequency and identification). The depositing device can then have a corresponding RFID reader which reads the RFID tag on the attachment component and assigns the attachment components to the correct depositing places.

In the depositing device, the depositing positions can be arranged on a turntable that can be rotated about an axis of rotation, whereby the depositing position can always be the same. The depositing places are thus optionally in a cleaning position for cleaning the stored attachment component or in a transfer position in which a depositing of an attachment component on the turntable or a removal of an attachment component from the turntable takes place. The rotation thus preferably makes it possible to position the individual depositing places optionally inside the depositing device or at least partially outside the depositing device.

As an alternative to a turntable, it is possible for the two depositing places to be arranged on one or more displacement devices (e.g. displacement tables). The displacement device can shift the depositing places between a cleaning position inside the depositing device (e.g. inside the paint booth) and a transfer position outside the depositing device (e.g. outside the paint booth). For cleaning, the deposit position with the electrode assembly to be cleaned is thus moved into the depositing device. For depositing or removal, on the other hand, the depositing place with the electrode arrangement to be cleaned or cleaned is moved out of the depositing device.

In a preferred embodiment of the disclosure, the displacement device enables the respective depositing place to be shifted transversely to the booth wall of the paint booth, i.e. in the horizontal direction. The displacement devices can thus be used to transport the charging rings into or out of the painting booth, whereby this displacement can be carried out manually or automatically.

In one variant of the disclosure, a separate deposit point can be provided for a dirty charging ring. Furthermore, a separate deposit point can be provided for a cleaned charging ring. Thus, different charging rings can also be provided for a painting robot, the different charging rings being adapted, for example, for interior painting or for exterior painting.

In the preferred embodiment of the disclosure, the displacement devices are arranged next to each other. Alternatively, however, it is also possible for the displacement devices to be arranged one above the other. Preferably, however, the displacement devices are arranged in the same booth wall of the painting booth.

Furthermore, a stacking accumulator can be provided which can accommodate several stacked charging rings. The displacement devices can then be supplied with the respective charging rings from the stacking accumulator.

The disclosure also provides for the possibility of attaching a cleaning device to the displacement devices.

In the preferred embodiment of the disclosure, two displacement devices are provided, each of which offers a depositing place. However, it is also possible within the scope of the disclosure for a larger number of displacement devices to be provided. This also makes it possible to change different types of charging rings (e.g. for exterior painting or for interior painting) on one painting robot.

An advantage of the disclosure is that no attachment component (e.g. charging ring) has to remain in the painting booth after it has been deposited, so that there is also no risk of soiling.

It should also be mentioned that the depositing device can be aligned horizontally, so that the attachment components are deposited on the depositing device or picked up by the depositing device in a vertical direction. Alternatively, however, it is also possible for the depositing device to be inclined to the horizontal, so that the attachment components are deposited at an angle on the depositing device or picked up at an angle by the depositing device.

In addition, the depositing device can have a swiveling device for swiveling the deposited attachment component, in particular about a horizontal swiveling axis. This can be advantageous in order to swivel the deposited attachment component into a particular cleaning position within the depositing device.

Furthermore, it should also be mentioned that the individual depositing places can each have a self-centering feature so that the attachment components to be deposited are automatically centered at the respective depositing place during depositing.

In addition, the depositing device can have a visual indicator which indicates whether the attachment component to be deposited has been deposited correctly. For example, this visual indicator can have a first signal light (e.g. a green LED) to indicate correct placement and a second signal light (e.g. a red LED) to indicate incorrect placement.

In general, it should also be mentioned that the atomizer is preferably guided by a painting robot arranged in a painting booth in which the components are painted. In this case, the components to be painted can be conveyed through the painting booth by a conveyor. A hand washing station can also be provided within the painting booth for manual cleaning of the attachment components. The cleaning station is preferably located in the cleaning area and not in the painting area.

In addition, a maintenance cell can be provided to service the painting robot and/or the atomizer. These maintenance cells can be arranged at the corners of the painting booth, for example. It is possible for the individual maintenance cells to be separated from the painting booth by a cell wall, which can be made of glass and/or sheet metal, for example. The maintenance cells can optionally also have their own ventilation system to ventilate the interior of the maintenance cell. The maintenance cells can have an insertion opening to allow the atomizer or a robot arm to be inserted into the maintenance cell.

The depositing device for depositing the attachment components of the atomizer can be arranged inside the maintenance cell. Alternatively, it is possible that the depositing device for depositing the attachment components of the atomizer is arranged outside the maintenance cell in the paint booth. Furthermore, it is also possible that one of the depositing places of the depositing device is arranged inside the maintenance cell, while another depositing place of the depositing device is arranged outside the maintenance cell inside the paint booth.

The cleaning device for cleaning the attachment components can be arranged outside the maintenance cell in the paint booth, in particular on the cell wall of the maintenance cell. Alternatively, it is possible for the cleaning device for cleaning the attachment components to be arranged inside the maintenance cell, in particular under the depositing device. The depositing device and the cleaning device can therefore be arranged one above the other.

It should also be mentioned that the cleaning device for cleaning the attachment components can be arranged in a fixed position in the painting booth. Alternatively, however, it is also possible that the cleaning device for cleaning the attachment components is attached to the painting robot and can be moved with the painting robot within the painting booth.

Above, the operating method according to the disclosure has been described in general terms. However, the disclosure also claims protection for a corresponding painting system which is adapted and suitable for carrying out the operating method according to the disclosure.

The painting system according to the disclosure firstly comprises an atomizer with an attachment component mounted thereon, as already described above. In addition, the painting system according to the disclosure comprises a painting robot which moves the atomizer.

The painting system according to the disclosure is now distinguished from the prior art by an exchange station which makes it possible to exchange the attachment component mounted on the atomizer with another attachment component. For example, the other attachment component may be an electrode assembly for interior painting, a protective cover, or a handling tool, as mentioned above with respect to the operating method according to the disclosure.

Further device features of the painting system according to the disclosure have already been described above with reference to the operating method according to the disclosure, so that a separate renewed description of these device features can be dispensed with.

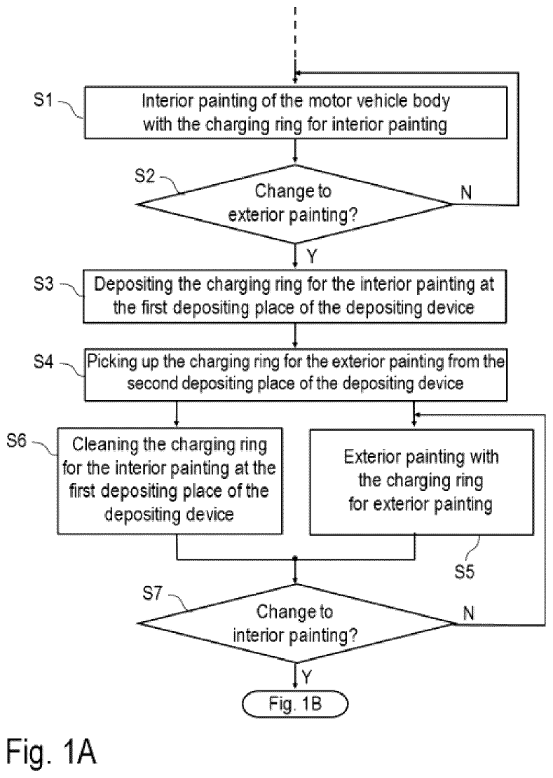

In the following, the flow diagram according to FIGS. 1A and 1B is now described, which serves to illustrate the operating method according to the disclosure.

In a first step S1, an interior painting of a motor vehicle body is carried out. For this purpose, a rotary atomizer with a charging ring (electrode arrangement) is used for electrostatic paint charging, the charging ring being optimized for interior painting. The charging ring therefore has only very short electrodes that barely protrude from the outer contour of the rotary atomizer, so that the rotary atomizer with the charging ring for interior painting requires relatively little space. This is important because there is relatively little room for movement of the rotary atomizer in the interior of the vehicle body.

In a step S2, it is then continuously checked whether the interior painting is to be terminated and an exterior painting is planned. If this is not the case, the operating method according to the disclosure continues the interior painting in step S1.

If there is a changeover to an exterior painting operation, the charging ring for the interior painting operation is, on the other hand, deposited at a first depositing place of a depositing device in a step S3. The charging ring for the interior painting is thus separated from the rotary atomizer and deposited.

In a further step S4, the rotary atomizer then picks up a charging ring for the exterior painting from a second depositing place of the depositing device. This charging ring has so-called fingers with embedded electrodes that protrude from the rotary atomizer and therefore require a relatively large amount of space. However, this is hardly a problem during exterior painting because there is sufficient room for the rotary atomizer to move during exterior painting.

The deposition of the charging ring for interior painting and the accommodation of the charging ring for exterior painting and also the structural design of the deposition device will be described in detail later.

Then, in step S5, the exterior painting can begin with the charging ring for the exterior painting.

Meanwhile, the deposited charging ring for interior painting can also be cleaned in a step S6, with the details of the cleaning process also described in more detail. The cleaning of the charging ring for interior painting in step S6 can thus be carried out during the exterior painting in step S5. This is advantageous because no interruption of the painting process is required for cleaning in step S6. Rather, the painting process only needs to be interrupted for the relatively short period of time required to switch from the charging ring for interior painting to the charging ring for exterior painting. However, this changeover time is much shorter than the cleaning time required to clean the interior painting charging ring in step S6.

In a step S7, it is then continuously checked again whether the exterior painting has been completed and whether it is time to switch back to the interior painting. If this is not the case, the operating method according to the disclosure continues the exterior painting in step S5.

Otherwise, the process proceeds to step S8, in which the charging ring for the exterior painting is deposited at the second depositing place of the depositing device. It should be mentioned here that the depositing device has an associated depositing place for each of the two charging rings. Thus, the first depositing place serves to receive the charging ring for the interior painting, while the second depositing place serves to receive the charging ring for the exterior painting. The two deposit positions are not interchangeable, as will be described in detail.

Then, in step S9, the rotary atomizer picks up the now cleaned charging ring for the interior painting from the first depositing place of the depositing device.

In the next step S10, the interior painting is again applied using the charging ring for the interior painting.

At the same time, the deposited charging ring for external painting is cleaned in step S11. Here again, the advantage is that the cleaning process in step S11 does not require any interruption of the painting process. Rather, the painting process only needs to be interrupted for the relatively short changeover time required to switch from the charging ring for exterior painting to the charging ring for interior painting.

In the next step S12, the system then continuously checks again whether the interior painting should be terminated in order to switch to the exterior painting.

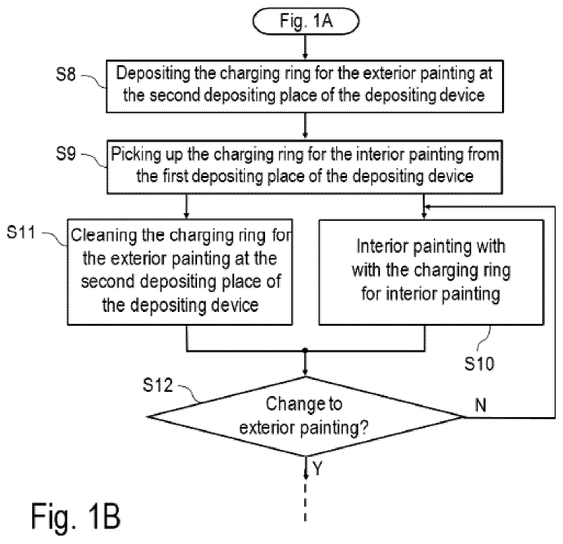

It was generally mentioned above that the depositing device has two depositing places for depositing the charging rings for the exterior painting and for the interior painting, respectively. FIGS. 2A-2C show various views of such a depositing place in the form of a deposition ring 1, which has a hole in the center into which a charging ring 2 can be inserted, the charging ring 2 being used for electrostatic external charging and being optimized for interior painting. The charging ring 2 therefore has electrodes 3 which are designed as stub electrodes and project only very slightly from the charging ring 2. This is important for interior painting, because for interior painting in the interior of motor vehicle bodies there is relatively little room for movement for the rotary atomizer with the charging ring 2, so that the charging ring 2 should have very compact external dimensions.

The charging ring 2 for interior painting can be locked in the deposition ring 1 by several swiveling clamping brackets 4.1-4.3.

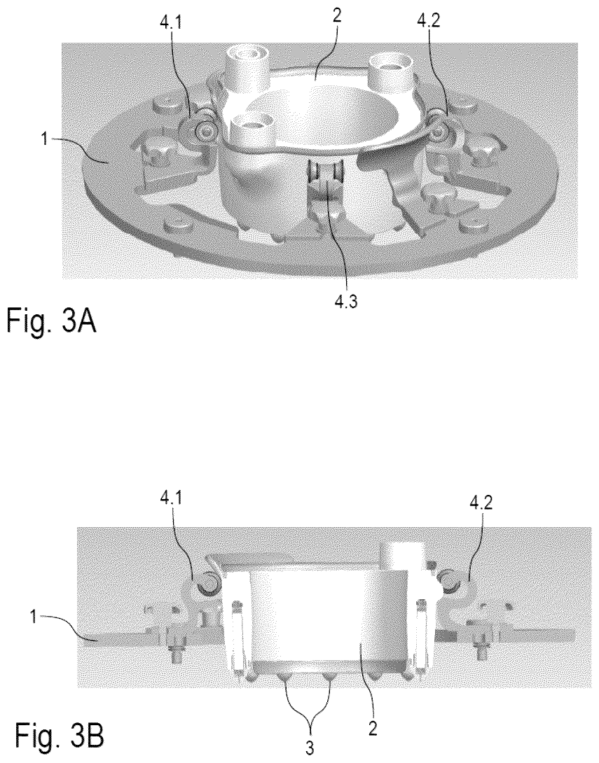

To place the charging ring 2 for interior painting in the deposition ring 1, the rotary atomizer with the mounted charging ring 2 is inserted coaxially into the deposition ring 1. The clamping brackets 4.1-4.3 are then locked and the connection between the rotary atomizer and the charging ring 2 is released. The rotary atomizer can then be removed from the deposition ring 1, leaving the charging ring 2 in the deposition ring 1. It should be mentioned here that the deposition ring 1 is interchange-proof. This means that only the charging ring 2 for the interior painting can be deposited in the deposition ring 1, whereas a charging ring 5 for the exterior painting (cf. FIG. 4) cannot be deposited in the deposition ring 1. To achieve this the non-interchangeability, locking surfaces 6 are used, which are screwed tightly into the deposition ring 1 and prevent the charging ring 5 for the exterior painting from being inserted and deposited.

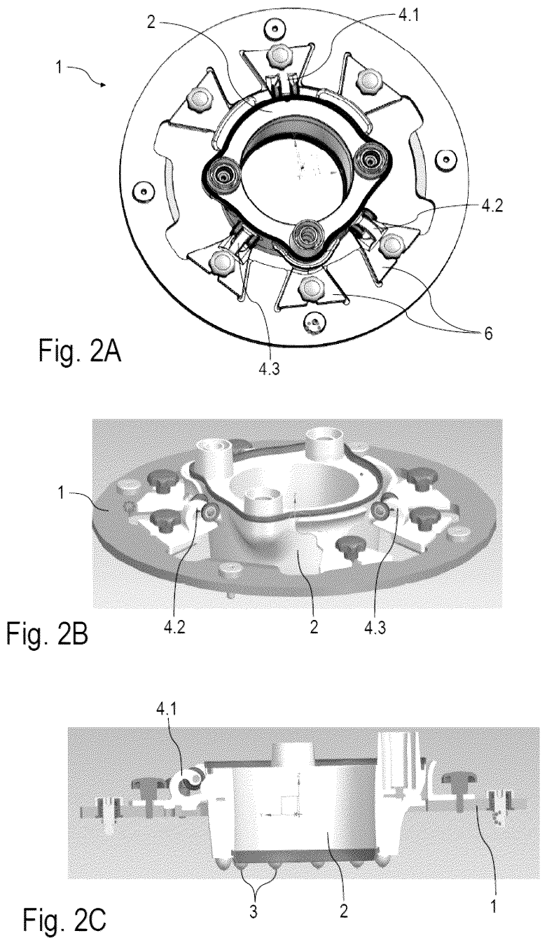

FIGS. 3A and 3B show a modification of the deposition ring 1 for depositing the charging ring 2 for interior painting. This modification largely corresponds to the design example according to FIGS. 2A-2C, so that reference is made to the above description in order to avoid repetition, the same reference signs being used for corresponding details.

The only difference here is the design of the clamping brackets 4.1-4.3.

FIG. 4 now shows a perspective view of a deposition ring 7, which is used to deposit the charging ring 5 for exterior painting and is adapted accordingly. It should be noted that the charging ring 5 for the exterior painting has several fingers 8 with embedded electrodes which project from the charging ring 5 and thus also from the rotary atomizer. As a result, the charging ring 5 for exterior painting requires a relatively large amount of space due to the protruding fingers 8, but this is hardly a nuisance during exterior painting.

The deposition ring 7 for the charging ring 5 for exterior painting has a recess 9 for receiving the individual fingers 8 of the charging ring 5, so that the individual fingers 8 of the charging ring 5 can be inserted into the recesses 9 in the deposition ring 7 when the charging ring 5 is deposited. It has already been briefly mentioned above that the recesses 9 in the other deposition ring 1 are partially closed by the blocking surfaces 6, so that the charging ring 5 cannot be deposited in the deposition ring 1 for exterior painting.

The deposition ring 7 also has a plurality of clamping brackets 10.1-10.4, which are pivotable and enable the charging ring 5 for external charging to be fixed in the deposition ring 7, as already described above with respect to the other deposition ring 1.

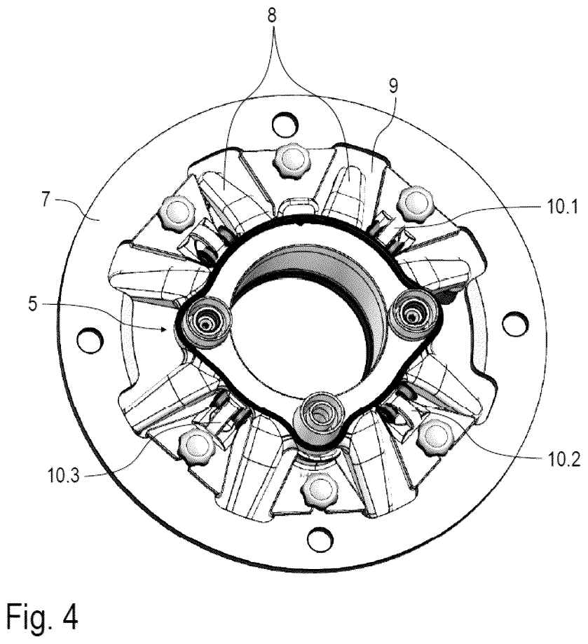

FIG. 5 shows, for ease of understanding, a perspective view of the charging ring 5 for exterior painting in the mounted state on a rotary atomizer 11, which is mounted on a robot hand axis 12 and has a bell cup 13 as an application element.

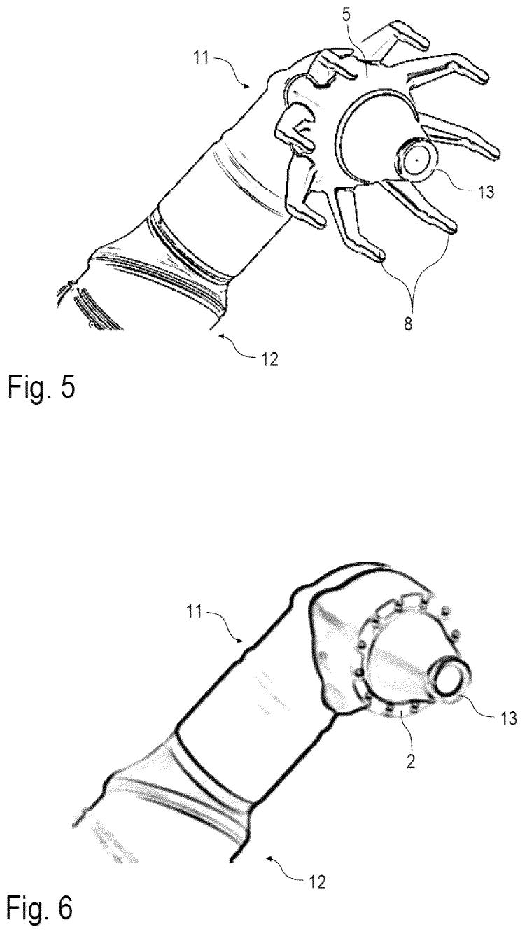

FIG. 6 shows a perspective view of the rotary atomizer 11, with the charging ring 2 for interior painting mounted on the rotary atomizer 11.

It is immediately apparent from a comparison of FIGS. 5 and 6 that the charging ring 5 for exterior painting requires considerably more space than the charging ring 2 for interior painting.

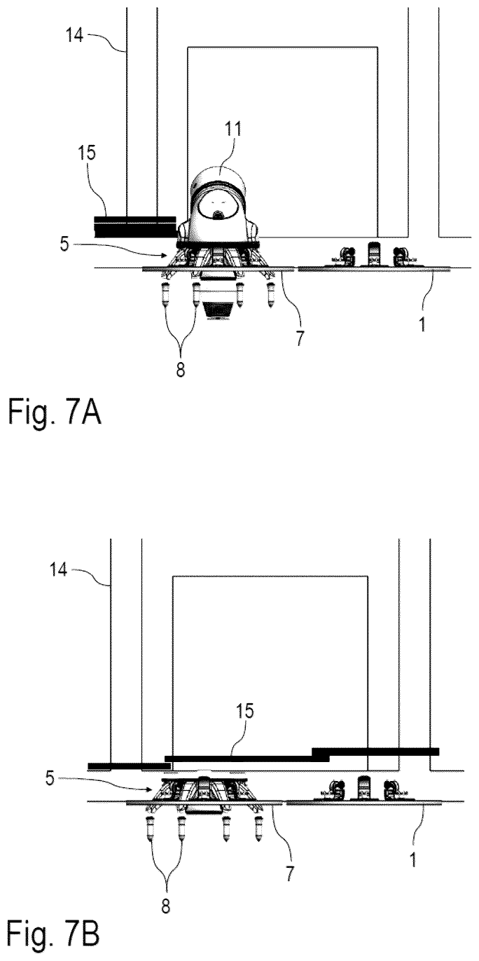

FIGS. 7A and 7B show a schematic representation of a depositing device 14 according to the disclosure with the two deposition rings 1, 7 for depositing the charging ring 2 for interior painting and the charging ring 5 for exterior painting, respectively.

The two deposition rings 1, 7 are each aligned horizontally and arranged next to one another in a common plane.

The depositing device 14 has an opening through which the painting robot can insert the rotary atomizer 11 with the mounted charging ring 2 or 5 in order to then change the charging ring 2 or 5.

A retractable cover 15 is arranged above the two deposition rings 1 and 7. FIG. 7A shows the retracted state of the cover 15, while FIG. 7B shows the extended state of the cover 15. In the retracted state according to FIG. 7A, it is possible to change the charging ring 2 or 5. In the extended state of the cover 15, however, the two deposition rings 1, 7 are not accessible.

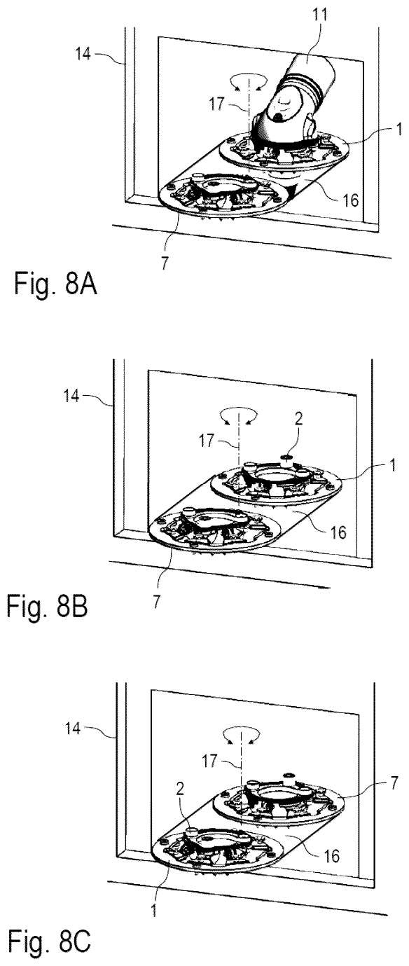

FIGS. 8A-8C show a different embodiment of the depositing device 14, whereby this embodiment partly corresponds to the embodiment described above and shown in FIGS. 7A, 7B, so that in order to avoid repetitions, reference is made to the above description, whereby the same reference signs are used for corresponding individual items.

A special feature of this embodiment is that the two deposition rings 1, 7 are arranged on a turntable 16, which is rotatable about a vertical axis of rotation 17. By rotating the turntable 16 about the axis of rotation 17, one of each of the two deposition rings 1, 7 can be positioned in a cleaning position inside the deposition device 14, while the other deposition ring 1 or 7 is in a transfer position that is accessible from the outside to allow deposition of the charging ring 2 or 5.

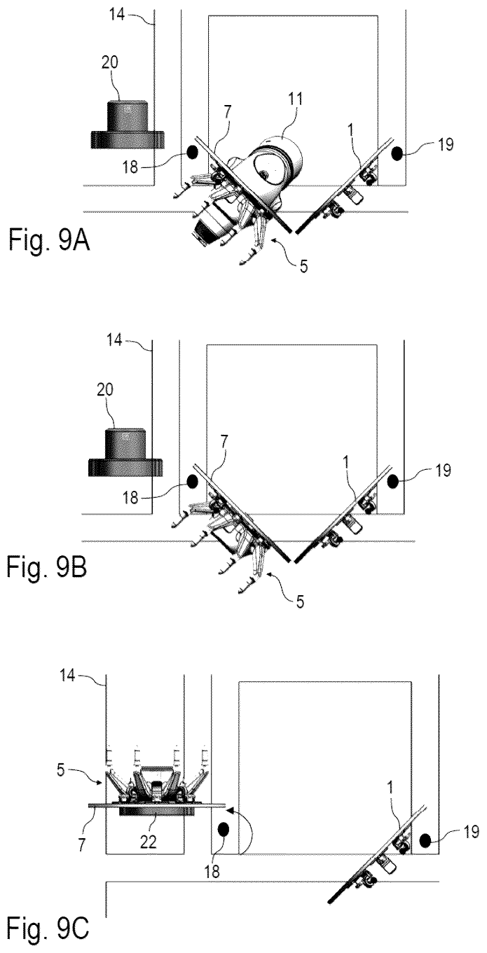

FIGS. 9A-9C show a further modified embodiment of the depositing device 14. This embodiment is again partially consistent with the embodiments described above, so that in order to avoid repetition, reference is made to the above description, with the same reference signs being used for corresponding details.

A special feature of this embodiment is that the two deposition rings 1, 7 are arranged at an angle in the depositing device 14 and can each be pivoted about a pivot axis 18 or 19. FIG. 9C shows how the deposition ring 7 for the charging ring 5 for exterior painting is pivoted onto a cleaning device 20, whereby the cleaning device 20 cleans the charging ring 5.

FIG. 9C thus shows the cleaning position of the deposition ring 7, while FIGS. 9A and 9B show the transfer position of the two deposition rings 1, 7, in which it is possible to change the charging ring 2 and 5, respectively.

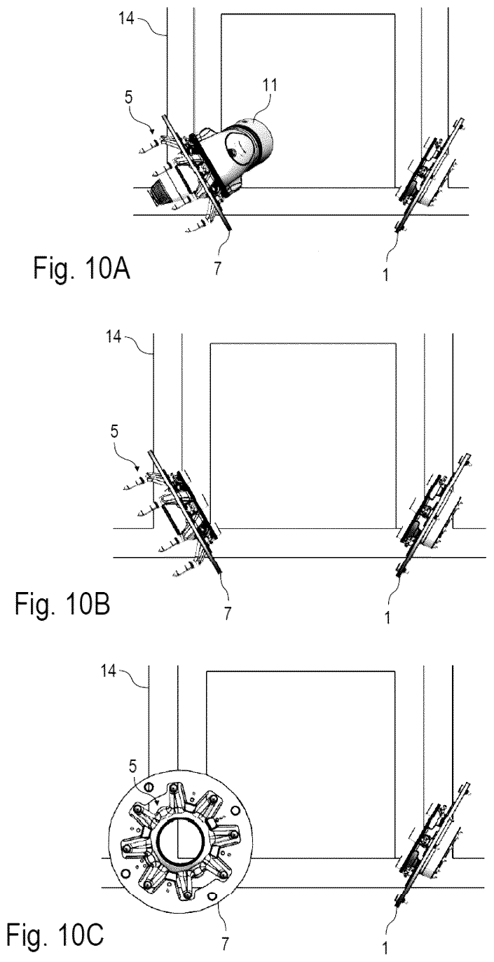

FIGS. 10A-10C show yet another embodiment of the depositing device 14, which is also partly identical to the embodiments described above, so that in order to avoid repetition, reference is made to the above description, the same reference signs being used for corresponding details.

A particular feature of this embodiment is that the deposition ring 7 is pivotable about a pivot axis which lies in the plane of the charging ring 7.

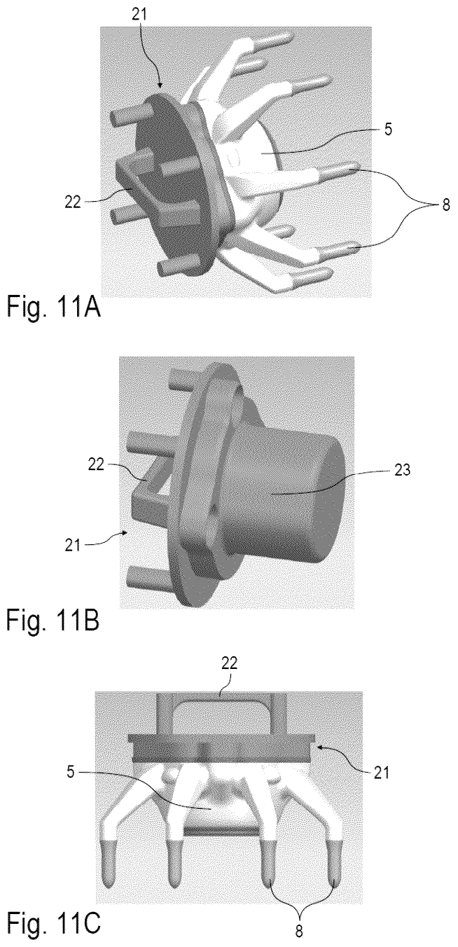

FIGS. 11A-11 C show various views of a protective handle 21 having a gripping handle 22 and a cylinder section 23. The cylinder section 23 can be inserted into the central bore of the charging ring 5 and connected to the charging ring 5, as can be seen in FIGS. 11A and 11C. Subsequently, the charging ring 2 can then be gripped by means of the gripping hill 22.

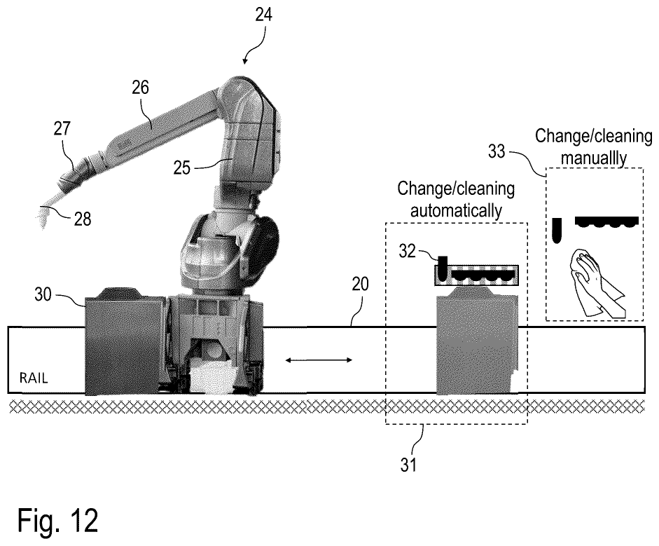

FIG. 12 shows a schematic representation of a painting robot 24 with two robot arms 25, 26 and a robot hand axis 27, on which a rotary atomizer 28 with a charging ring for electrostatic paint charging is mounted. The painting robot 24 can be moved in the direction of the double arrow on a traversing rail 29, and a cleaning device 30 is mounted on the painting robot 24, which is permanently connected to the painting robot 24 and moves along the traversing rail 29 with the painting robot 24. The cleaning device 30 serves to clean the rotary atomizer 28, which can be inserted into the cleaning device 30 for this purpose.

Furthermore, a station 31 is provided for automatically changing a charging ring 32 and for cleaning a charging ring 32.

Further, another station 33 is provided for manually changing and cleaning a charging ring 32, as indicated by the symbol.

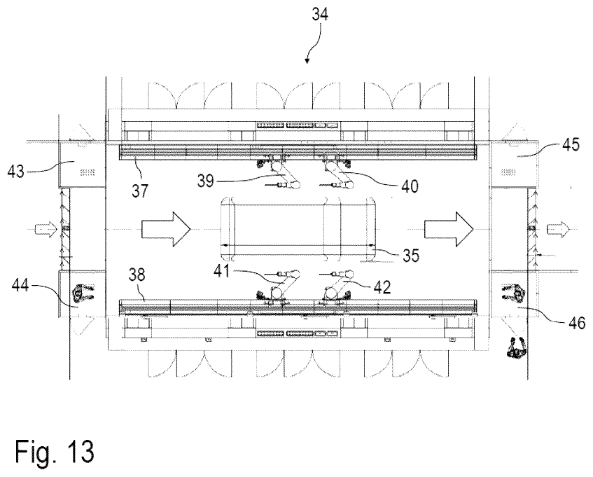

FIG. 13 shows a top view of a painting booth 34, where a motor vehicle body 35 can be conveyed on a conveyor 36 in the direction of the double arrows through the painting booth 34. In the painting booth 34, on both sides of the conveyor path, there are two traversing rails 37, 38 on which several painting robots 39-42 can be moved.

At the corners of the painting booth 32 are several maintenance cells 43-46 for changing the charging rings and also for cleaning the charging rings, as described above.

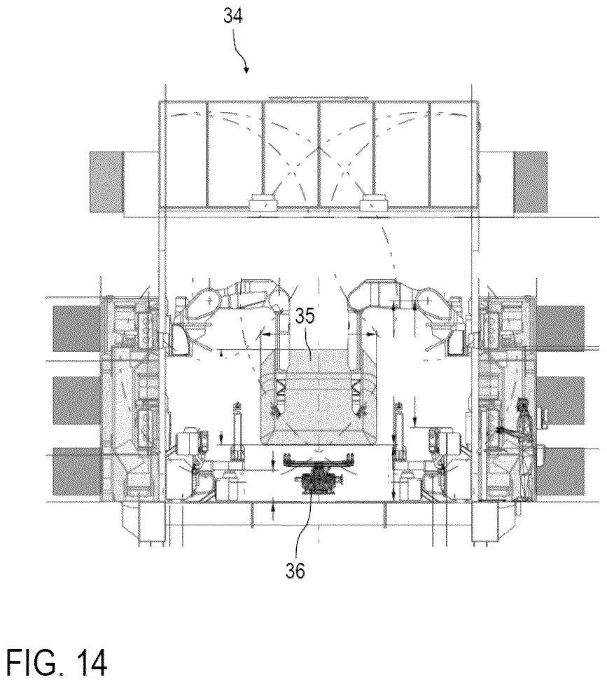

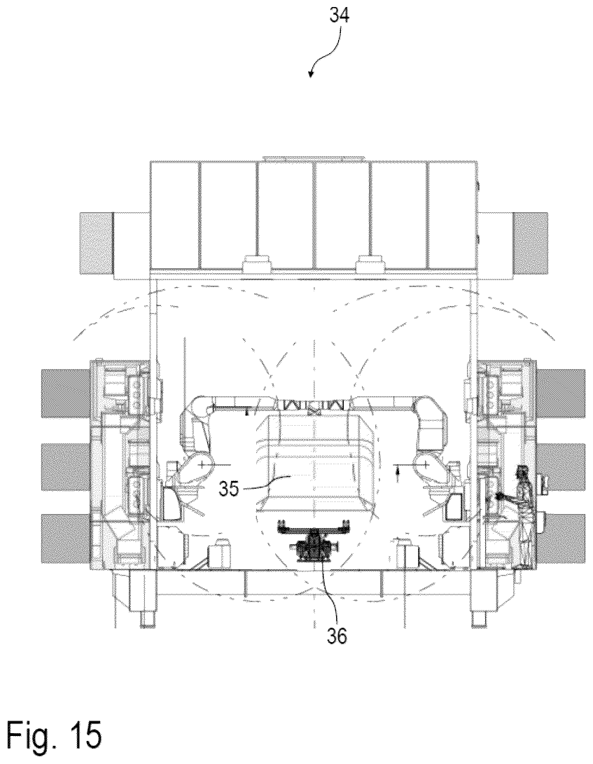

FIGS. 14 and 15 show different embodiments with a total of eight painting robots (FIG. 14) or four painting robots (FIG. 15) within the painting booth 1. In the arrangement of eight painting robots according to FIG. 14, these are arranged in two levels one above the other.

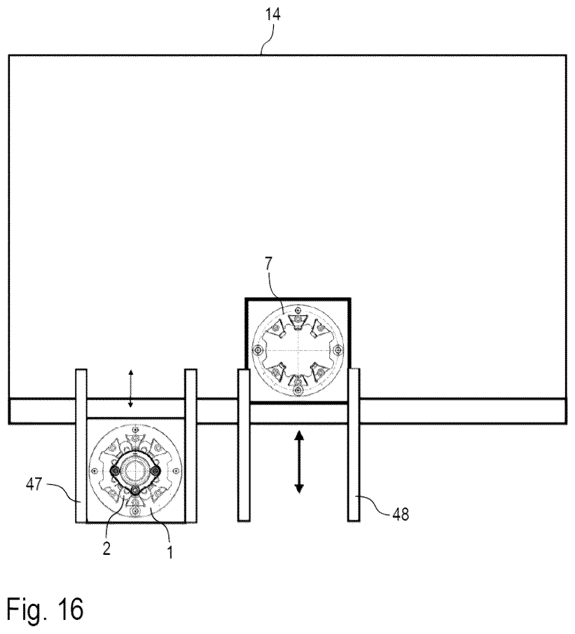

FIG. 16 shows a modification of FIGS. 8A-8C, so that in order to avoid repetition, reference is made to the description of FIGS. 8A-8C, with the same reference signs being used for corresponding individual items.

A special feature of this embodiment is that two displacement devices 47, 48 are provided instead of turntable 16.

The displacement device 47 makes it possible to position the deposition ring 1 for the charging ring 2 for interior painting either inside the depositing device 14 (i.e. in the painting booth) or outside the depositing device 14 (i.e. outside the painting booth) by shifting the deposition ring 1 in the direction of the double arrow. The drawing shows the deposition ring 1 outside the depositing device 14.

The displacement device 48, on the other hand, makes it possible to position the other deposition ring 7 for the charging ring 5 for the exterior painting either inside the depositing device 14 (i.e. in the painting booth) or outside the depositing device 14 (i.e. outside the painting booth) by shifting the deposition ring 7 in the direction of the double arrow. The drawing shows the deposition ring 7 inside the depositing device 14.

1.-39. (canceled)

40. An operating method for an atomizer for painting components with a paint, comprising:
a) painting with the atomizer with a first component mounted thereon, and
b) replacing the attachment component on the atomizer with a second component.

41. The operating method according to claim 40, wherein the first component is an electrode arrangement suitable for painting outer surfaces of the motor vehicle body components for electrostatic external charging of the applied paint.

42. The operating method according to claim 41, wherein the second component is selected from a group consisting of the following attachment components:
a) an electrode arrangement suitable for painting a body interior of the motor vehicle body components for electrostatic external charging,
b) a protective cover for an exchange interface on the atomizer,
c) a handling tool for handling vehicle components.

43. The operating method according to claim 42, further comprising the following steps for replacing the components:
a) dismantling the first component mounted on the atomizer from the atomizer, and
b) depositing the first component dismantled from the atomizer in a depositing device,
c) mounting the second component on the atomizer.

44. The operating method according to claim 43, further comprising:
cleaning the first component.

45. The operating method according to claim 40, wherein the first and second components each have a gripping contour in order to be able to grip the attachment components in a form-fitting and/or friction-fitting manner.

46. The operating method according to claim 40, wherein the replacement of components requires a shorter time than the cleaning of components.

47. The operating method according to claim 40, wherein the exchange of components is carried out robot-assisted.

48. The operating method according to claim 40, wherein the atomizer with the first component paints the components, while the second component is cleaned.

49. The operating method according to claim 40, wherein
a) the same atomizer is used for both interior painting and exterior painting, and
b) the first component is used for the interior painting, and
c) the second component is used for the exterior painting.

50. The operating method according to claim 40, wherein
a) the atomizer has a coupling mechanism for releasable mounting or dismantling of the first and second components and,
b) the coupling mechanism comprises at least one of the following components:
b1) a ball clamping mechanism,
b2) a magnetic coupling,
b3) a vacuum cup,
b4) an adhesive connection,
b5) at least one clamping bracket,
c) the coupling mechanism comprises an operating element for releasing the connection between the atomizer and the attachment component, the operating element being arranged on the attachment component, so that the coupling mechanism can be released by acting on the operating element on the attachment component.

51. The operating method according to claim 43, wherein
a) the depositing device has a first depositing place for depositing the first component,
b) the depositing device has a second depositing place for depositing the second component,
c) the two depositing places being non-interchangeable.

52. The operating method according to claim 51, wherein the non-interchangeability of the depositing places is achieved mechanically.

53. The operating method according to claim 51, wherein the non-interchangeability is achieved by sensors which can distinguish between the depositing places and/or the attachment components.

54. The operating method according to claim 51, wherein
a) the two depositing places are arranged on a turntable,
b) the turntable can be rotated about an axis of rotation, so that the depositing places are located in a cleaning position for cleaning the component or in a transfer position in which a depositing of the component on the turntable or a removal of the component from the turntable takes place.

55. The operating method according to claim 51, wherein the two depositing places are arranged on a displacement device and the displacement device can displace the depositing places between a cleaning position and a transfer position.

56. The operating method according to claim 51, wherein the two depositing places are aligned horizontally, so that the components are deposited on the depositing device or picked up by the depositing device in the vertical direction.

57. The operating method according to claim 51, wherein the two depositing places are aligned inclined to the horizontal, so that the components are deposited at an angle on the depositing device or picked up at an angle by the depositing device.

58. The operating method according to claim 51, wherein the depositing device has a pivoting device for pivoting the deposited component.

59. The operating method according to claim 51, wherein the first depositing place and/or the second depositing place has a self-centering device for automatically centering the component to be deposited during the deposit.

60. The operating method according to claim 43, wherein
a) the depositing device has a visual display which indicates whether or not the component to be deposited is correctly deposited,
b) the display has a first signal light for signalling correct deposition and a second signal light for signalling incorrect deposition.

61. The operating method according to claim 40, wherein
a) the atomizer is guided by a painting robot,
b) the painting robot is arranged in a painting booth, the painting booth including a conveyor, and hand-washing station for manual cleaning of the components of the atomizer.

62. The operating method according to claim 61, wherein
a) at least one maintenance cell is provided to maintain the painting robot and/or the atomizer,
b) a maintenance cell is arranged at one or more corners of the painting booth,
c) the maintenance cell is separated from the paint booth by a cell wall,
d) the maintenance cell has a ventilation system for ventilating the interior of the maintenance cell,
e) the maintenance cell has an insertion opening in order to be able to insert the atomizer and/or a robot arm into the maintenance cell,
f) the maintenance cell has an opening through which attached cleaning devices can be moved wholly or partially into the maintenance cell in order to carry out maintenance work on the cleaning devices.

63. The operating method according to claim 62, wherein
a) the depositing device for depositing the components of the atomizer is arranged within the maintenance cell, or
b) the depositing device for depositing the components of the atomizer is arranged outside the maintenance cell in the paint booth, or
c) one of the depositing places of the depositing device is arranged within the maintenance cell, while the other depositing place of the depositing device is outside the maintenance cell in the painting booth is arranged.

64. The operating method according to claim 62, wherein
a) the cleaning device for cleaning the attachment components is arranged outside the maintenance cell in the painting booth.

66. The operating method according to claim 40, wherein
a) the cleaning device for cleaning the components is arranged in a stationary manner in the painting booth, or
b) the painting robot can be moved within the painting booth, the cleaning device for cleaning the components being attached to the painting robot and can be moved with the painting robot.
